(19) United States
(12) Patent Application Publication
(10) Pub. No.: US 2026/0360305 A1
(43) Pub. Date: Nov. 12, 2026

(54) LED DISPLAY DRIVING DEVICE

(71) Applicant: LX Semicon Co., Ltd., Daejeon (KR)

(72) Inventors: Yoon Soo SHIN, Daejeon (KR); Jong Min LEE, Daejeon (KR); Jin Ho CHOI, Daejeon (KR); Sang Suk KIM, Daejeon (KR); Jang Su KIM, Daejeon (KR); Ji Hwan KIM, Daejeon (KR)

(73) Assignee: LX Semicon Co., Ltd., Daejeon (KR)

(21) Appl. No.: 19/669,477

(22) Filed: May 6, 2026

(30) Foreign Application Priority Data
May 7, 2025 (KR) 10-2025-0059417

(51) Int. Cl. G09G 3/32

(52) U.S. Cl. CPC G09G 3/32; G09G 2300/0814; G09G 2310/0267; G09G 2310/0275; G09G 2310/0278; G09G 2310/0291; G09G 2320/0214; G09G 2320/045; G09G 2330/021

(57) ABSTRACT

An embodiment of the present disclosure provides an LED display driving device including an LED driver IC configured to drive a plurality of LEDs arranged for each of a plurality of display areas included in a display panel, wherein the LED driver IC includes a master driver IC and a slave driver IC configured to receive data and a clock from the master driver IC, wherein each of the master driver IC and the slave driver IC includes a scan driver having a plurality of main scan drivers configured to respectively drive a plurality of scan lines, and wherein the LED display driving device further includes a scan driver IC having a plurality of sub scan drivers configured to respectively share corresponding scan lines with the plurality of main scan drivers.

### CROSS-REFERENCE TO RELATED APPLICATIONS

This application claims the benefit of the Korean Patent Application No. 10-2025-0059417 filed on May 7, 2025, which is hereby incorporated by reference as if fully set forth herein.

### BACKGROUND

### Field of the Invention

The present disclosure relates to an LED display driving device in which a turn-on resistance (Ron) value is reduced.

### Description of the Related Art

A display device may be implemented in various ways. For example, the display device may be classified into an LCD display device or an LED display device.

Mini-LED elements or micro-LED elements may be used in the LED display device. Accordingly, a required number of modularized LED elements may be arranged. Therefore, a large-sized display device such as signage may be easily implemented.

However, as a display device includes a large number of LED modules, the number of required driver ICs may also increase. Accordingly, the amount of current handled by a scan transistor of a driver IC may increase, and thus a scan voltage may rise.

As a result, an image grayscale deviation (crosstalk) phenomenon may occur in a high-luminance model display device. The image grayscale deviation (crosstalk) may refer to a phenomenon in which a signal of a specific pixel affects an adjacent pixel, thereby causing an undesired color change or luminance difference.

Recently, research for preventing the image grayscale deviation (crosstalk) phenomenon in a high-luminance model display device has been continuously conducted.

### SUMMARY

An embodiment of the present disclosure provides an LED display driving device in which a turn-on resistance (Ron) value is reduced.

An embodiment of the present disclosure provides an LED display driving device with reduced power consumption.

Another embodiment of the present disclosure provides an LED display driving device with improved leakage current.

In order to achieve the above technical objects, an embodiment of the present disclosure provides an LED display driving device including an LED driver IC configured to drive a plurality of LEDs arranged for each of a plurality of display areas included in a display panel, wherein the LED driver IC includes a master driver IC and a slave driver IC configured to receive data and a clock from the master driver IC, wherein each of the master driver IC and the slave driver IC includes a scan driver including a plurality of main scan drivers configured to respectively drive a plurality of scan lines, and wherein the LED display driving device further includes a scan driver IC including a plurality of sub scan drivers configured to respectively share corresponding scan lines with the plurality of main scan drivers.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a configuration of an LED display device according to an embodiment of the present disclosure.

FIG. 2 is a view illustrating a partial area of a display panel according to an embodiment of the present disclosure.

FIG. 3 is a view illustrating configurations of a master driver IC and a slave driver IC according to an embodiment of the present disclosure.

FIG. 4A is a view illustrating a portion of an LED display driving device according to an embodiment of the present disclosure.

FIG. 4B is an operation timing diagram of the LED display driving device shown in FIG. 4A.

FIG. 5A is a view illustrating a portion of an LED display driving device according to another embodiment of the present disclosure.

FIG. 5B is an operation timing diagram of the LED display driving device shown in FIG. 5A.

FIG. 6 is an operation timing diagram of an LED display driving device according to an embodiment of the present disclosure.

FIG. 7 is an operation timing diagram of an LED display driving device in a normal mode according to the present disclosure.

FIG. 8 is an operation timing diagram of an LED display driving device in a low power mode according to the present disclosure.

FIG. 9 is an operation timing diagram of an LED display driving device in another low power mode according to the present disclosure.

FIG. 10 is an operation timing diagram of an LED display driving device in still another low power mode according to the present disclosure.

### DETAILED DESCRIPTION OF THE DISCLOSURE

Advantages and features of the present disclosure and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete and will fully convey the scope of the present disclosure to those skilled in the art. Further, the present disclosure is only defined by scopes of claims.

A shape, a size, a ratio, an angle and a number disclosed in the drawings for describing embodiments of the present disclosure are merely an example and thus, the present disclosure is not limited to the illustrated details. Like reference numerals refer to like elements throughout the specification. In the following description, when the detailed description of the relevant known function or configuration is determined to unnecessarily obscure the important point of the present disclosure, the detailed description will be omitted.

In a case where ‘comprise’, ‘have’ and ‘include’ described in the present disclosure are used, another portion may be added unless ‘only~’ is used. The terms of a singular form may include plural forms unless referred to the contrary.

In construing an element, the element is construed as including an error band although there is no explicit description.

In describing a position relationship, for example, when the position relationship is described as ‘upon~’, ‘above~’, ‘below~’ and ‘next to~’, one or more portions may be disposed between two other portions unless ‘just’ or ‘direct’ is used.

In describing a position relationship, for example, when the position relationship is described as ‘upon~’, ‘above~’, ‘below~’, and ‘next to~’, one or more portions may be arranged between two other portions unless ‘just’ or ‘direct’ is used. Spatially relative terms such as "below", “beneath”, “lower”, “above”, and “upper” may be used herein to easily describe a relationship of one element or elements to another element or elements as illustrated in the figures. It will be understood that these terms are intended to encompass different orientations of the device in addition to the orientation depicted in the figures. For example, if the device illustrated in the figure is reversed, the device described to be arranged “below”, or “beneath” another device may be arranged “above” another device. Therefore, an exemplary term “below or beneath” may include “below or beneath” and “above” orientations. Likewise, an exemplary term “above” or “on” may include “above” and “below or beneath” orientations.

In describing a temporal relationship, for example, when the temporal order is described as “after,” “subsequent,” “next,” and “before,” a case which is not continuous may be included, unless “just” or “direct” is used.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

It should be understood that the term “at least one” includes all combinations related with any one item. For example, “at least one among a first element, a second element and a third element” may include all combinations of two or more elements selected from the first, second and third elements as well as each element of the first, second and third elements.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in a co-dependent relationship.

In adding reference numerals to elements of each drawing describing embodiments of the present disclosure, the same elements may have the same reference numerals as possible even though they are shown on different drawings.

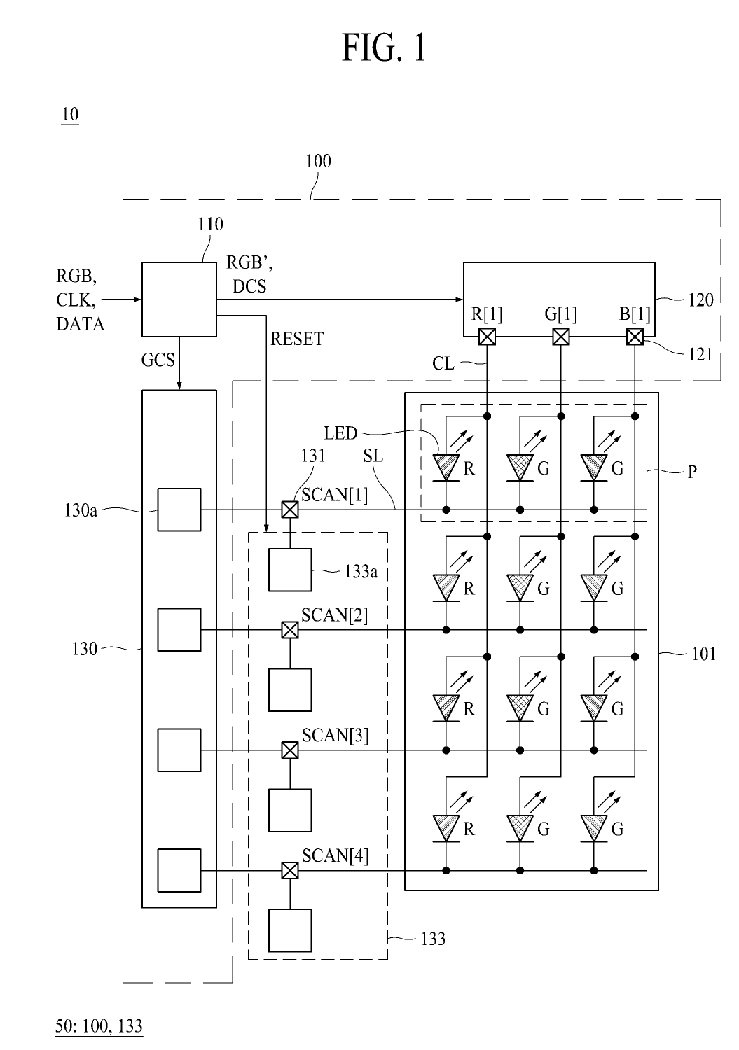

FIG. 1 is a view illustrating a configuration of an LED display device (10) according to an embodiment of the present disclosure.

According to an embodiment of the present disclosure, the LED display device (10) may include a display panel (101) and an LED display driving device (50). In detail, the LED display driving device (50) may include an LED driver IC (100) and a scan driver IC (133). The LED driver IC (100) may include a display controller (110), a data driver (120), and a scan driver (130). For example, the LED driver IC (100) may include a master driver IC (100a) and a slave driver IC (100b), and each of the master driver IC (100a) and the slave driver IC (100b) may include a display controller (110), a data driver (120), and a scan driver (130). Although not shown in the drawings, the LED display device (10) may further include a power supply circuit (not shown). The display panel (101), the display controller (110), the data driver (120), the scan driver (130), and the scan driver IC (133) will be described in detail below.

According to an embodiment of the present disclosure, the display panel (101) performs a display function and may be implemented as an LED display. The display panel (101) of the present disclosure may further perform a touch sensing function.

According to an embodiment of the present disclosure, the display panel (101) may include a plurality of scan lines (SL), a plurality of channel lines (CL), and a plurality of pixels (P).

According to an embodiment of the present disclosure, each of the plurality of pixels (P) may include a plurality of subpixels (R, G, B). For example, the pixel (P) may include a subpixel (R) representing red, a subpixel (G) representing green, and a subpixel (B) representing blue. However, the types of subpixels included in the pixel (P) are not limited thereto and may vary depending on embodiments.

According to an embodiment of the present disclosure, each of the subpixels (R, G, B) may include an LED. That is, the display panel (101) may be an LED display panel.

The plurality of pixels (P) may be connected to each other in a horizontal direction through the scan lines (SL). In addition, the plurality of pixels (P) may be connected to each other in a vertical direction through the channel lines (CL). The scan lines (SL) and the channel lines (CL) may be arranged to cross each other to define the subpixels (R, G, B). Accordingly, the plurality of pixels (P) may be arranged to form a matrix.

The plurality of pixels (P) may include a thin film transistor (not shown) connected to adjacent scan lines (SL) and channel lines (CL), a pixel electrode (not shown) connected to the thin film transistor, and a storage capacitor (not shown) connected to the pixel electrode.

According to an embodiment of the present disclosure, the display controller (110) may receive various signals from an external system (not shown), generate a data control signal (DCS; Data Control Signal) for driving the data driver (120), and generate a gate control signal (GCS; Gate Control Signal) for driving the scan driver (130). In addition, the display controller (110) may receive a vertical synchronization signal (V_{SYNC}) from the external system.

The display controller (110) may control the data driver (120) and the scan driver (130).

The display controller (110) aligns image data (RGB) received from the external system. In detail, the display controller (110) aligns image data to conform to the structure and characteristics of the display panel (101). The display controller (110) transfers the aligned image data (RGB') to the data driver (120).

The data control signal (DCS) may include a source start pulse (SSP), a source sampling clock (SSC), a source output enable signal (SOE), a PWM signal (T_{PWM_R1}), and a channel-off signal (T_{OFF_R1}), and the gate control signal (GCS) may include a gate start pulse (GSP), a gate shift clock (GSC), a gate output enable signal, and a scan signal (T_{SCAN_ON1}).

According to an embodiment of the present disclosure, the data driver (120) converts the aligned image data (RGB') into a data signal according to a timing signal generated by the display controller (110). In detail, the data driver (120) converts the aligned image data (RGB') into the data signal according to the source start pulse, the source sampling clock, and the source output enable signal. The data driver (120) outputs a data signal corresponding to one horizontal line to a data line for each horizontal period in which a scan signal is supplied to the scan line (SL). In this case, the data driver (120) may receive a gamma voltage from a gamma voltage generator (not shown) and may convert the aligned image data (RGB') into the data signal using the gamma voltage.

According to an embodiment of the present disclosure, the data driver (120) may include a plurality of channel stages (121).

The plurality of channel stages (121) may include a first red channel stage (R[1]), a first green channel stage (G[1]), and a first blue channel stage (B[1]). Although only the first red channel stage (R[1]), the first green channel stage (G[1]), and the first blue channel stage (B[1]) are illustrated in FIG. 1, the plurality of channel stages (121) may include more channel stages.

The plurality of channel stages (121) may supply LED power to the display panel (101) through the plurality of channel lines (CL) based on the data signal.

Each of the plurality of channel stages (121) may be connected to an LED of the display panel (101) through one channel line (CL). Each of the plurality of channel stages (121) may be sequentially connected to the display panel (101) in a vertical direction through one channel line (CL).

According to an embodiment of the present disclosure, the scan driver (130) outputs a scan input signal synchronized with the data signals generated by the data driver (120) to the scan lines (SL) according to a timing signal generated by the display controller (110). In detail, the scan driver (130) outputs the scan input signal synchronized with the data signals to the scan lines (SL) according to the gate start pulse, the gate shift clock, and the gate output enable signal generated by the display controller (110).

The scan driver (130) may include a gate shift register circuit and a gate level shifter circuit.

According to an embodiment of the present disclosure, the scan driver (130) may include a plurality of output stages (131).

The plurality of output stages (131) may include a first output stage (SCAN[1]), a second output stage (SCAN[12]), a third output stage (SCAN[3]), and a fourth output stage (SCAN[4]). Although only the first output stage (SCAN[1]), the second output stage (SCAN[12]), the third output stage (SCAN[3]), and the fourth output stage (SCAN[4]) are illustrated in FIG. 1, the plurality of output stages (131) may include more output stages.

The plurality of output stages (131) may supply driving power to the display panel (101) through the plurality of scan lines (SL) based on the scan signal.

Each of the plurality of output stages (131) may be connected to an LED of the display panel (101) through one scan line (SL). Each of the plurality of output stages (131) may be sequentially connected to the display panel (101) in a horizontal direction through one scan line (SL).

The power supply circuit (not shown) generates various signals required by the data driver (120) and the scan driver (130). For example, the power supply circuit generates an analog power source and a digital power source by boosting or stepping down a system voltage.

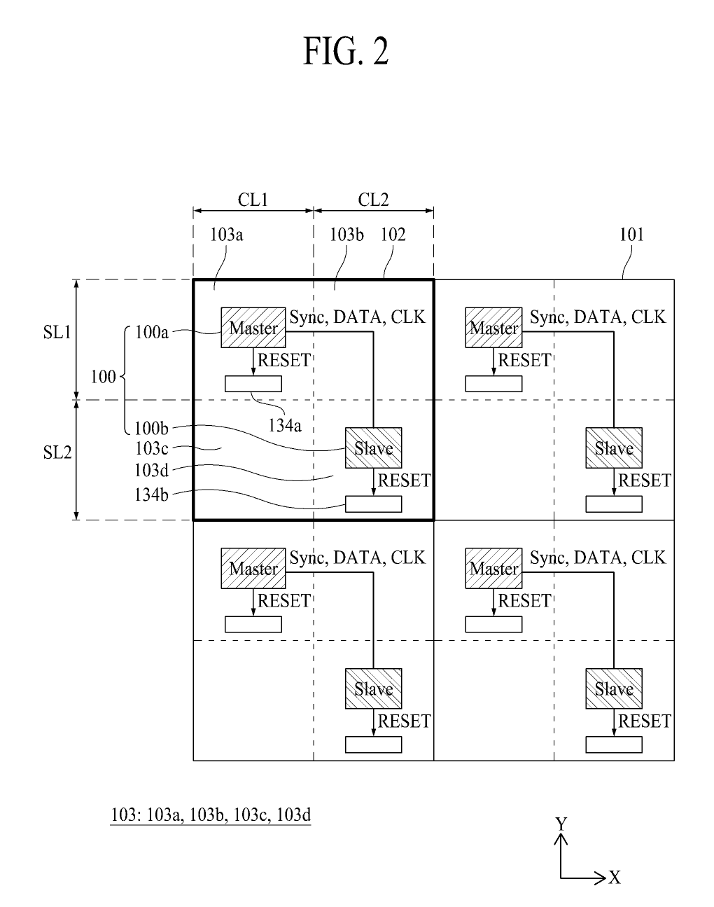

FIG. 2 is a view illustrating a partial area of the display panel (101) according to an embodiment of the present disclosure.

According to an embodiment of the present disclosure, the display panel (101) may include a plurality of display areas (102). Referring to FIG. 2, the plurality of display areas (102) are arranged in a matrix form to constitute one display panel (101). The LED display device (10) of the present disclosure may be implemented as a single large display device such as digital signage or an electronic display, in which the plurality of display areas (102) are coupled or assembled, or as a single small display device such as a monitor for a personal computer or a TV, but is not limited thereto.

Although FIG. 2 illustrates four display areas (102) constituting the display panel (101), various numbers of display areas (102) may be coupled to implement the display panel (101).

According to an embodiment of the present disclosure, the display area (102) may include a plurality of display units (103). The plurality of display units (103) may include M+1 rows and M+1 columns, where M is a natural number greater than or equal to 1.

Although FIG. 2 illustrates four display units (103) constituting the display area (102), nine display units (103) may be arranged in a 3×3 matrix form.

In detail, FIG. 2 illustrates a first display unit (103a), a second display unit (103b), a third display unit (103c), and a fourth display unit (103d). In detail, in a first direction (X), the first display unit (103a) and the second display unit (103b) are arranged adjacent to each other, and the third display unit (103c) and the fourth display unit (103d) are arranged adjacent to each other. In addition, in a second direction (Y), the first display unit (103a) and the third display unit (103c) are arranged adjacent to each other, and the second display unit (103b) and the fourth display unit (103d) are arranged adjacent to each other.

According to an embodiment of the present disclosure, the LED display driving device (50) may include an LED driver IC (100) and a scan driver IC (133). The LED driver IC (100) may include a master driver IC (100a) and a slave driver IC (100b). The master driver IC (100a) may output a synchronization signal (Sync) to the slave driver IC (100b). The scan driver IC (133) may include a first scan driving group (134a) and a second scan driving group (134b).

The master driver IC (100a) may drive a first scan line group (SL1) corresponding to the first display unit (103a) and the second display unit (103b), which are adjacent to each other in the first direction (X) among the plurality of display units (103), and a first channel line group (CL1) corresponding to the first display unit (103a) and the third display unit (103c), which are adjacent to each other in the second direction (Y).

The slave driver IC (100b) may drive a second scan line group (SL2) corresponding to the third display unit (103c) and the fourth display unit (103d), which are adjacent to each other in the first direction (X) among the plurality of display units (103), and a second channel line group (CL2) corresponding to the second display unit (103b) and the fourth display unit (103d), which are adjacent to each other in the second direction (Y).

According to an embodiment of the present disclosure, the LED driver IC (100) may include one master driver IC (100a) and M slave driver ICs (100b) for each display area (102). In detail, when the display area (102) is composed of display units (103) arranged in M+1 rows and M+1 columns, the LED driver IC (100) may include one master driver IC (100a) and M slave driver ICs (100b).

According to an embodiment of the present disclosure, the master driver IC (100a) may be disposed at a first column of a first row, and the slave driver IC (100b) may be disposed at an N-th column of an N-th row, where N is a natural number greater than 1 and less than or equal to M+1. Referring to FIG. 2, the master driver IC (100a) and the slave driver IC (100b) may be arranged side by side in a diagonal direction based on rows and columns. The arrangement structure of the master driver IC (100a) and the slave driver IC (100b) of the present disclosure is not limited thereto. For example, referring to FIG. 2, the master driver IC (100a) may be disposed in the first display unit (103a), and the slave driver IC (100b) may be disposed in the fourth display unit (103d).

According to an embodiment of the present disclosure, the first scan driving group (134a) of the scan driver IC (133) may be disposed in a display unit (103) corresponding to the master driver IC (100a), and the second scan driving group (134b) may be disposed in a display unit (103) corresponding to the slave driver IC (100b).

For example, referring to FIG. 2, the first scan driving group (134a) may be disposed in the first display unit (103a), and the second scan driving group (134b) may be disposed in the fourth display unit (103d). The first scan driving group (134a) and the second scan driving group (134b) will be described in detail below.

According to an embodiment of the present disclosure, the first scan driving group (134a) may include a plurality of sub scan drivers (133a) corresponding to the first scan line group (SL1), and the second scan driving group (134b) may include a plurality of sub scan drivers (133a) corresponding to the second scan line group (SL2).

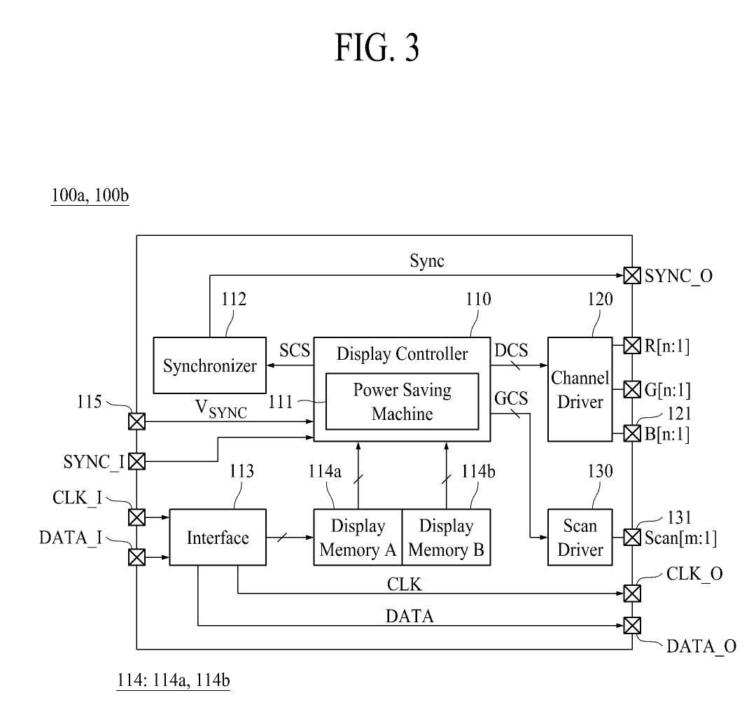

A description of the configurations of the master driver IC (100a) and the slave driver IC (100b) will be given in detail with reference to FIG. 3.

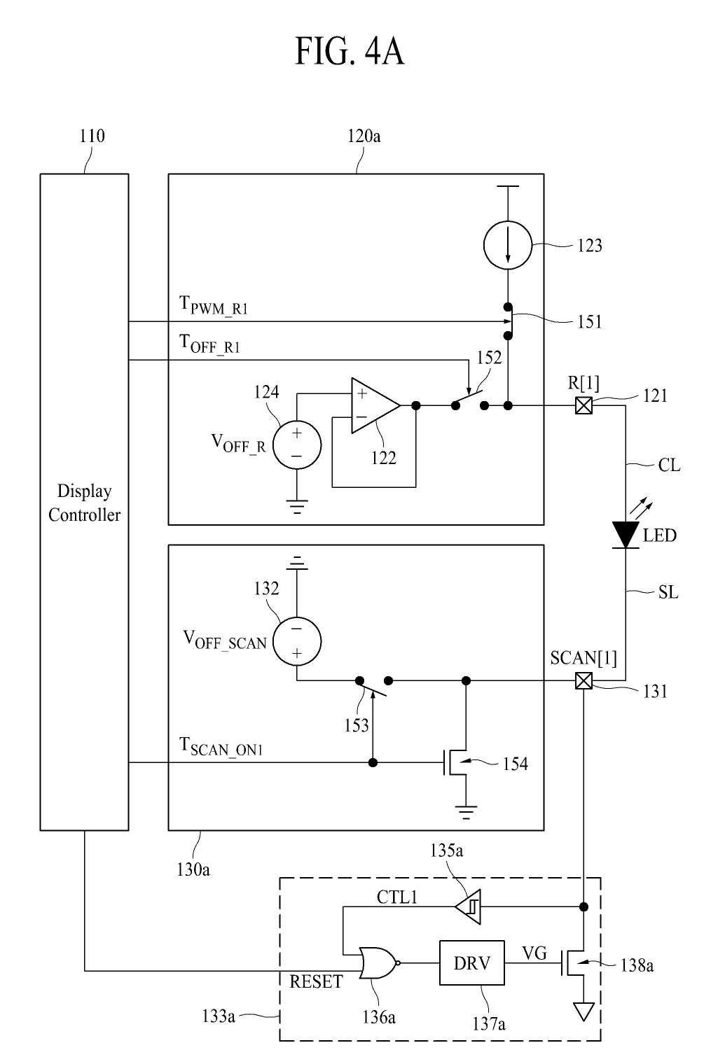

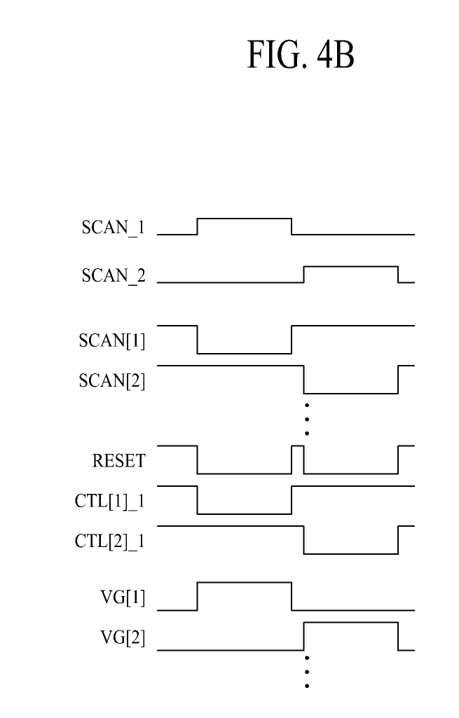

FIG. 3 is a view illustrating configurations of the master driver IC (100a) and the slave driver IC (100b) according to an embodiment of the present disclosure. FIG. 4A is a view illustrating a portion of the LED display driving device (50) according to an embodiment of the present disclosure.

The configurations of the master driver IC (100a) and the slave driver IC (100b) are identical to each other.

According to an embodiment of the present disclosure, each of the master driver IC (100a) and the slave driver IC (100b) may include a data driver (120), a scan driver (130), and a display controller (110). The data driver (120), the scan driver (130), and the display controller (110) illustrated in FIG. 3 may respectively correspond to the data driver (120), the scan driver (130), and the display controller (110) described with reference to FIG. 1. In this case, the data driving unit (120) may be referred to as a “channel driver.”

According to an embodiment of the present disclosure, each of the master driver IC (100a) and the slave driver IC (100b) may include an interface (113), a data storage unit (114), a power reduction determination unit (111), a synchronization unit (112), a Vsync input terminal (115), a synchronization signal input terminal (SYNC_I), a synchronization signal output terminal (SYNC_O), a data input terminal (DATA_I), a clock input terminal (CLK_I), a data output terminal (DATA_O), and a clock output terminal (CLK_O).

The interface (113) may receive frame data input from the outside. In detail, the interface (113) may serve to transfer the frame data input from the outside to the data storage unit (114). In detail, data (DATA) and a clock (CLK) may be output from a data input terminal (DATA_I) and a clock input terminal (CLK_I) to a data output terminal (DATA_O) and a clock output terminal (CLK_O) through the interface (113). More specifically, the data (DATA) and the clock (CLK) may be transferred from the interface (113) provided in the master driver IC (100a) to the interface (113) provided in the slave driver IC (100b) through the data output terminal (DATA_O) and the clock output terminal (CLK_O).

The data input from the outside may include data (DATA) transferred through the data input terminal (DATA_I) and a clock (CLK) transferred through the clock input terminal (CLK_I).

The data storage unit (114) may serve to store the frame data provided from the interface (113). The data storage unit (114) may include a first data storage unit (114a) and a second data storage unit (114b). Such a data storage unit (114) may be referred to as a “display memory,” and the first data storage unit (114a) and the second data storage unit (114b) may be referred to as a “display memory A” and a “display memory B,” respectively.

The first data storage unit (114a) and the second data storage unit (114b) may sequentially store frame data. For example, after the first data storage unit (114a) stores frame data transferred first, the second data storage unit (114b) may store frame data transferred second. Although only the first data storage unit (114a) and the second data storage unit (114b) are illustrated in FIG. 3, the present disclosure is not limited thereto and may include three or more data storage units.

The data storage unit (114) may transfer the stored frame data to the display controller (110).

A description of the display controller (110) is omitted because the same has been described above with reference to FIG. 1.

According to an embodiment of the present disclosure, the display controller (110) may include a power reduction determination unit (111). Such a power reduction determination unit (111) may be referred to as a “power saving machine.”

The power reduction determination unit (111) may serve to determine whether to operate in a low power mode or a normal mode, which will be described below, based on the frame data transferred from the data storage unit (114). In detail, the power reduction determination unit (111) provided in each of the master driver IC (100a) and the slave driver IC (100b) may determine whether the data driver (120) and the scan driver (130) of each of the master driver IC (100a) and the slave driver IC (100b) operate in a low power mode or a normal mode.

In detail, since the data input from the outside is transferred to the respective power reduction determination units (111) after passing through the interface (113) of each of the master driver IC (100a) and the slave driver IC (100b), the master driver IC (100a) and the slave driver IC (100b) may know each other’s data information. Accordingly, the power reduction determination unit (111) of each of the master driver IC (100a) and the slave driver IC (100b) may determine whether the respective data driver (120) and scan driver (130) operate in a low power mode or a normal mode.

The synchronization unit (112) may output a synchronization signal (Sync) in response to a synchronizer control signal (SCS) output from the display controller (110). Such a synchronization unit (112) may be referred to as a “synchronizer.”

The synchronization signal (Sync) may be output from the synchronization unit (112) of the master driver IC (100a), pass through the synchronization signal output terminal (SYNC_O), pass through the synchronization signal input terminal (SYNC_I) of the slave driver IC (100b), and be transferred to the display controller (110) of the slave driver IC (100b).

Based on the synchronization signal (Sync) output from the master driver IC (100a), a scan signal of the master driver IC (100a) may be synchronized with a scan signal of the slave driver IC (100b). In detail, the synchronization signal (Sync) output from the master driver IC (100a) includes scan information corresponding to the master driver IC (100a). That is, the synchronization signal (Sync) transfers the scan information corresponding to the master driver IC (100a) to the slave driver IC (100b), such that the slave driver IC (100b) may determine whether to perform a scan operation.

FIG. 4A is a view illustrating a portion of an LED display driving device (50) according to an embodiment of the present disclosure. In detail, FIG. 4A is a view for explaining a principle according to which the LED display driving device (50) is driven in a low power mode or a normal mode.

Each of the master driver IC (100a) and the slave driver IC (100b) may be driven in a low power mode or a normal mode. In detail, the data driver (120) and the scan driver (130) of each of the master driver IC (100a) and the slave driver IC (100b) may be driven in a low power mode or a normal mode.

Referring to FIG. 4A, the data driver (120) according to the present disclosure may include a plurality of sub data drivers (120a). Each of the plurality of sub data drivers (120a) may supply a data voltage to a corresponding channel line (CL). In FIG. 4A, one sub data driver (120a) among the plurality of sub data drivers (120a) of the data driver (120) is illustrated. In detail, when the master driver IC (100a) is responsible for 40 channel lines (CL), the data driver (120) of the master driver IC (100a) may include 40 sub data drivers (120a).

Referring to FIG. 4A, the scan driver (130) according to the present disclosure may include a plurality of main scan drivers (130a). Each of the plurality of main scan drivers (130a) may drive a corresponding scan line (SL). In detail, the plurality of main scan drivers (130a) may respectively drive the plurality of scan lines. In FIG. 4A, one main scan driver (130a) among the plurality of main scan drivers (130a) of the scan driver (130) is illustrated. In detail, when the master driver IC (100a) is responsible for 36 scan lines (SL), the scan driver (130) of the master driver IC (100a) may include 36 main scan drivers (130a).

Components for driving each of the master driver IC (100a) and the slave driver IC (100b) in a low power mode or a normal mode will be described in detail below.

The data driver (120) may include a plurality of first switches (151) respectively connecting the plurality of channel stages (121) and the plurality of channel current sources (123).

The plurality of first switches (151) may be turned on or turned off according to the PWM signal (T_{PWM_R1}) transferred from the display controller (110).

The plurality of first switches (151) may be switches for controlling the channel current described below. For example, the plurality of first switches (151) may be PWM switches. The amount of channel current supplied through each channel line (CL) may be determined according to the time during which the plurality of first switches (151) are turned on. Accordingly, the brightness or color of the pixel (P) may be determined. This channel current may be supplied to a plurality of LEDs to cause the plurality of LEDs to emit light.

The plurality of channel current sources (123) may generate channel current using LED power. The channel current generated by each of the plurality of channel current sources (123) may be supplied to the pixels (P) connected in a vertical direction through one channel line (CL).

The data driver (120) may include a plurality of second switches (152) respectively connecting the plurality of channel stages (121) and the plurality of AMPs (122).

The plurality of second switches (152) may be turned on or turned off according to the channel-off signal (T_{OFF_R1}) transferred from the display controller (110).

Each of the plurality of AMPs (122) may be connected to a channel-off voltage source (124) supplying a channel-off voltage (V_{OFF_R}). The plurality of AMPs (122) may control an output voltage based on the channel-off voltage (V_{OFF_R}). In detail, the AMP (122) may amplify a difference between the channel-off voltage (V_{OFF_R}) output from the channel-off voltage source (124) and a voltage fed back from the output stage, and may output the amplified difference to the output stage.

Referring to FIG. 4A, the sub data driver (120a) according to an embodiment of the present disclosure may include a first switch (151), a channel current source (123), a second switch (152), an AMP (122), and a channel-off voltage source (124).

The scan driver (130) may include a plurality of third switches (153) respectively connecting the plurality of output stages (131) and the plurality of scan offset voltage sources (132). In detail, the plurality of third switches (153) may be connected by the plurality of LEDs and the plurality of scan offset voltage sources (132).

The plurality of third switches (153) may be turned on or turned off according to the scan signal (T_{SCAN_ON1}) transferred from the display controller (110).

Each of the plurality of third switches (153) may be connected to a scan offset voltage source (132) supplying a scan-off voltage (V_{OFF_SCAN}).

The scan driver (130) may include a plurality of first scan transistors (154), one ends of which are connected to the plurality of output stages (131) and the other ends of which are grounded.

The plurality of first scan transistors (154) may be turned on or turned off according to the scan signal (T_{SCAN_ON1}) transferred from the display controller (110). In detail, the plurality of first scan transistors (154) may be respectively connected to the plurality of scan lines (SL), selectively turned on or off according to the scan signal (T_{SCAN_ON1}), and select the scan lines (SL) connected to LEDs to emit light.

According to an embodiment of the present disclosure, the data driver (120) being driven in the low power mode means that all switches corresponding to some or all of the plurality of channel stages (121) in the data driver (120) are turned off. For example, referring to FIG. 4A, when the first switch (151) and the second switch (152) corresponding to the first red channel stage (R[1]) are turned off, the data driver (120) including the first red channel stage (R[1]) may be considered to be driven in the low power mode.

In addition, the scan driver (130) being driven in the low power mode means that the third switch (153) corresponding to some or all of the plurality of output stages (131) in the scan driver (130) is maintained in a turn-on state, and the first scan transistor (154) is maintained in a turn-off state. For example, referring to FIG. 4A, when the third switch (153) corresponding to the first output stage (SCAN[1]) is maintained in a turn-on state and the first scan transistor (154) is maintained in a turn-off state, the scan driver (130) including the first output stage (SCAN[1]) may be considered to be driven in the low power mode.

Referring to FIG. 4A, the main scan driver (130a) according to an embodiment of the present disclosure may include a third switch (153), a first scan transistor (154), and a scan offset voltage source (132). For example, each of the plurality of first scan transistors (154) may be provided in a corresponding one of the plurality of main scan drivers (130a).

According to an embodiment of the present disclosure, the LED display driving device (50) may further include a scan driver IC (133). The scan driver IC (133) may include a plurality of sub scan drivers (133a). Referring to FIG. 4A, each sub scan driver (133a) may share the scan line (SL) with the main scan driver (130a). In detail, the plurality of main scan drivers (130a) and the plurality of sub scan drivers (133a) may respectively share the plurality of scan lines (SL).

Unlike a case in which one display unit (103) includes a corresponding master driver IC (100a) or slave driver IC (100b), in the LED display driving device, the scan driver (130) of the master driver IC (100a) may drive the first scan line group (SL1) corresponding to the first display unit (103a) and the second display unit (103b), which are adjacent to each other in the first direction (X), among the plurality of display units (103). In this case, the amount of current handled by one scan line (SL) may increase twofold, and accordingly the voltage applied to the scan line (SL) may increase. As a result, an image grayscale deviation (crosstalk) phenomenon may occur in a high-luminance model display device. The image grayscale deviation (crosstalk) may refer to a phenomenon in which a signal of a specific pixel affects an adjacent pixel, thereby causing an undesired color change or luminance difference.

In order to solve the above problem, the LED display driving device (50) according to the present disclosure may further include a scan driver IC (133). In detail, the sub scan driver (133a) of the scan driver IC (133) may share the scan line (SL) with the main scan driver (130a) of the scan driver (130), thereby reducing a turn-on resistance (Ron) applied to the scan line (SL) during scan driving.

When the turn-on resistance (Ron) applied to the scan line (SL) is reduced, the voltage applied to the scan line (SL) may be reduced. Accordingly, occurrence of an image grayscale deviation (crosstalk) phenomenon in a high-luminance model display device may be prevented. In addition, when the voltage applied to the scan line (SL) is reduced, the voltage applied to a capacitor is also reduced, such that capacitance of the capacitor may increase.

Referring to FIG. 4A, each of the plurality of sub scan drivers (133a) of the scan driver IC (133) according to an embodiment of the present disclosure may include a second scan transistor (138a), an input buffer (135a), a NOR gate (136a), and an inverter chain (137a).

According to an embodiment of the present disclosure, the scan driver IC (133) may include a plurality of second scan transistors (138a) turned on or off by a gate driving signal (VG) synchronized with the scan signal (T_{SCAN_ON1}) for turning on or off the first scan transistor (154). For example, FIG. 4A illustrates the second scan transistor (138a) provided in the sub scan driver (133a) of the scan driver IC (133).

According to an embodiment of the present disclosure, the first scan transistor (154) of the main scan driver (130a) and the second scan transistor (138a) of the sub scan driver (133a) may share one scan line (SL).

The sub scan driver (133a) illustrated in FIG. 4A may include the input buffer (135a), the NOR gate (136a), and the inverter chain (137a) in order to synchronize the scan signal (T_{SCAN_ON1}) for turning on or off the first scan transistor (154) with the gate driving signal (VG).

According to an embodiment of the present disclosure, the input buffer (135a) may receive a voltage applied to a corresponding scan line (SL) among the plurality of scan lines (SL) and may output a first control signal (CTL1). According to an embodiment of the present disclosure, the voltage applied to the scan line (SL) may be referred to as a scan input signal.

The input buffer (135a) according to an embodiment of the present disclosure may remove a noise component of the scan input signal and transfer a stable signal to the NOR gate (136a). When the voltage applied to the scan line (SL) is at a high level, the input buffer (135a) may change and transfer the voltage to match an internal logic power voltage of the scan driver IC (133).

According to an embodiment of the present disclosure, the NOR gate (136a) may receive the first control signal (CTL1) and a reset signal (RESET) supplied from the LED driver IC (100) and may output a first signal. According to an embodiment of the present disclosure, the reset signal (RESET) is output from the display controller (110) of the master driver IC (100a) or the slave driver IC (100b).

According to an embodiment of the present disclosure, the inverter chain (137a) may receive the first signal output from the NOR gate (136a) and may output the gate driving signal (VG). In detail, the inverter chain (137a) may buffer the first signal output from the NOR gate (136a) so as to drive the second scan transistor (138a).

According to an embodiment of the present disclosure, each of the plurality of second scan transistors (138a) may be provided in a corresponding one of the plurality of sub scan drivers (133a).

FIG. 4B is an operation timing diagram of the LED display driving device (50) illustrated in FIG. 4A.

Referring to FIG. 4B, when the scan signals (SCAN_1, SCAN_2) increase from a low level to a high level, the scan input signals (SCAN[1], SCAN[2]) may decrease from a high level to a low level. In this case, the scan signals (SCAN_1, SCAN_2) may correspond to the scan signal (T_{SCAN_ON1}). The scan input signals (SCAN[1], SCAN[2]) may be voltages applied to scan lines.

Referring to FIG. 4B, when the scan input signals (SCAN[1], SCAN[2]) are at a high level, the first control signals (CTL[1]_1, CTL[2]_1) may be at a high level, and when the scan input signals (SCAN[1], SCAN[2]) are at a low level, the first control signals (CTL[1]_1, CTL[2]_1) may be at a low level.

Referring to FIG. 4B, in the NOR gate (136a), when two inputs are low, a high output is generated, and when one of the two inputs is high, a low output is generated. For example, when the first control signals (CTL[1]_1, CTL[2]_1) and the reset signal (RESET) are input to the NOR gate (136a), the gate driving signal (VG) is output. In this case, when both the first control signals (CTL[1]_1, CTL[2]_1) and the reset signal (RESET) are high, the gate driving signal (VG) is low, and when both the first control signals (CTL[1]_1, CTL[2]_1) and the reset signal (RESET) are low, the gate driving signal (VG) is high. The gate driving signals (VG[1], VG[2]) illustrated in FIG. 4B may correspond to the gate driving signal (VG) according to the present disclosure.

According to an embodiment of the present disclosure, through the input buffer (135a), the NOR gate (136a), and the inverter chain (137a), the scan signals (SCAN_1, SCAN_2) and the gate driving signal (VG) may be synchronized. Although FIG. 4B illustrates a state in which the scan signals (SCAN_1, SCAN_2) and the gate driving signal (VG) are completely synchronized, the present disclosure is not limited thereto, and the gate driving signal (VG) may be delayed relative to the scan signals (SCAN_1, SCAN_2).

According to the present disclosure, an operation of the sub scan driver (133a) of the scan driver IC (133) may be determined by the reset signal (RESET). For example, regardless of whether the main scan driver (130a) operates, the operation of the sub scan driver (133a) may be limited by maintaining the reset signal (RESET) at a high level.

According to an embodiment of the present disclosure, when the scan signals (SCAN_1, SCAN_2) are low, the gate driving signal (VG) is maintained low. Accordingly, when the main scan driver (130a) does not operate, the sub scan driver (133a) may also not operate. As a result, power consumption of the LED display driving device (50) may be reduced.

However, the present disclosure is not limited thereto, and even when the main scan driver (130a) operates, the sub scan driver (133a) may not operate by maintaining the reset signal (RESET) at a high level.

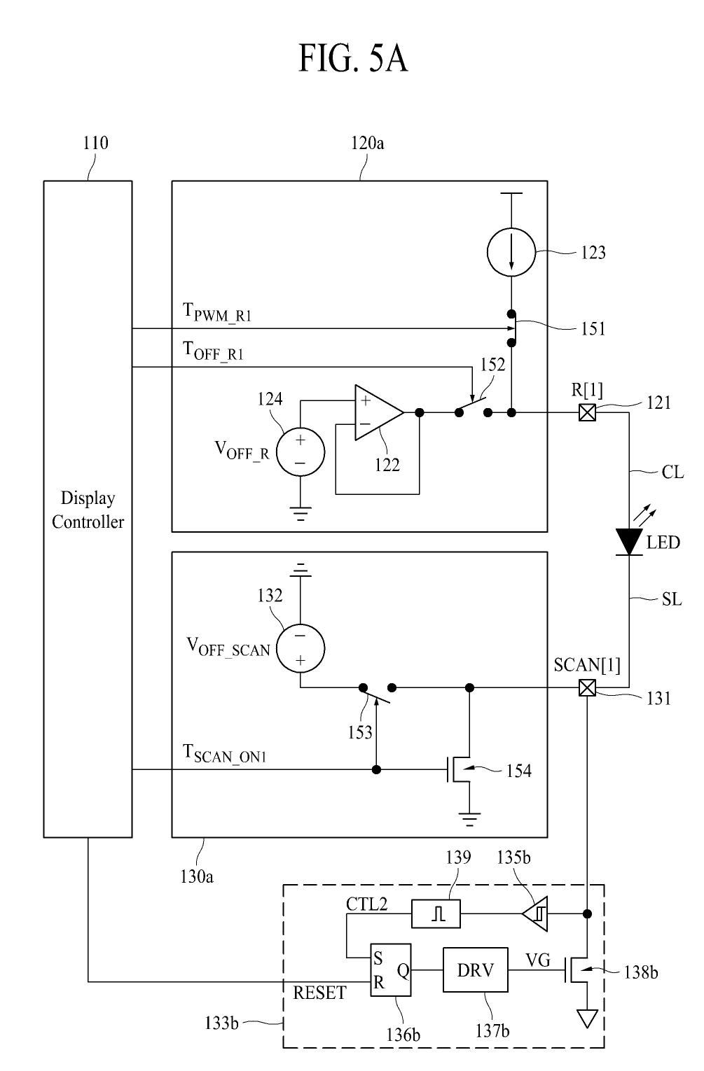

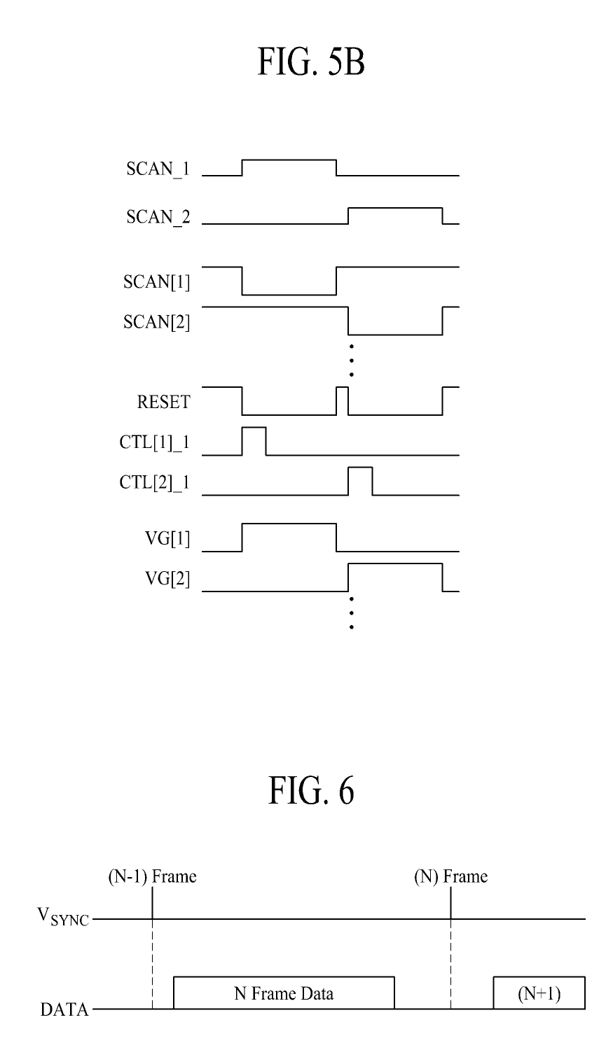

FIG. 5A is a view illustrating a portion of an LED display driving device (50) according to another embodiment of the present disclosure.

Referring to FIG. 5A, each of the plurality of sub scan drivers (133b) of the scan driver IC (133) according to an embodiment of the present disclosure may include a second scan transistor (138b), an input buffer (135b), a short pulse generator (139), an SR latch (136b), and an inverter chain (137b).

The second scan transistor (138b), the input buffer (135b), and the inverter chain (137b) illustrated in FIG. 5A may correspond to the second scan transistor (138a), the input buffer (135a), and the inverter chain (137a) illustrated in FIG. 4A. Among descriptions of the second scan transistor (138b), the input buffer (135b), and the inverter chain (137b) illustrated in FIG. 5A, descriptions overlapping those given with reference to FIG. 4A are omitted.

The sub scan driver (133b) illustrated in FIG. 5A may include the input buffer (135b), the SR latch (136b), the inverter chain (137b), and the short pulse generator (139) in order to synchronize the scan signal (T_{SCAN_ON1}) for turning on or off the first scan transistor (154) with the gate driving signal (VG).

According to an embodiment of the present disclosure, the input buffer (135b) may receive a voltage applied to a corresponding scan line (SL) among the plurality of scan lines (SL) and may output a second signal.

According to an embodiment of the present disclosure, the short pulse generator (139) may receive the second signal output from the input buffer (135b) and may output the second signal as a short-pulse second control signal (CTL[1]_2, CTL[2]_2). The short pulse generator (139) according to the present disclosure may convert the second signal into the second control signal (CTL2) using an internal delay circuit.

According to an embodiment of the present disclosure, the SR latch (136b) may receive the second control signal (CTL2) and the reset signal (RESET) supplied from the LED driver IC (100) at a set terminal (S) and a reset terminal (R), respectively, latch the same, and output a third signal.

According to an embodiment of the present disclosure, the inverter chain (137b) may receive the third signal output from the SR latch (136b) and may output the gate driving signal (VG).

FIG. 5B is an operation timing diagram of the LED display driving device (50) illustrated in FIG. 5A.

Referring to FIG. 5B, when the scan signals (SCAN_1, SCAN_2) increase from a low level to a high level, the scan input signals (SCAN[1], SCAN[2]) may decrease from a high level to a low level. In this case, the scan signals (SCAN_1, SCAN_2) may correspond to the scan signal (T_{SCAN_ON1}). The scan input signals (SCAN[1], SCAN[2]) may be voltages applied to scan lines.

Referring to FIG. 5B, when the scan input signals (SCAN[1], SCAN[2]) are at a low level, the second control signals (CTL[1]_2, CTL[2]_2) may be at a high level for a short pulse, and may be at a low level during the remaining period other than the high-level period of the short pulse.

Referring to FIG. 5B, in the SR latch (136b), when both inputs supplied to the set terminal (S) and the reset terminal (R) are low, a previous output state is maintained; when the input supplied to the set terminal (S) is low and the input supplied to the reset terminal (R) is high, a low output is generated; and when the input supplied to the set terminal (S) is high and the input supplied to the reset terminal (R) is low, a high output is generated. For example, when the second control signals (CTL[1]_2, CTL[2]_2) and the reset signal (RESET) are input to the set terminal (S) and the reset terminal (R) of the SR latch (136b), respectively, the gate driving signal (VG) is output. In this case, when the second control signals (CTL[1]_2, CTL[2]_2) are low and the reset signal (RESET) is high, the gate driving signal (VG) is low, and when the second control signals (CTL[1]_2, CTL[2]_2) are high and the reset signal (RESET) is low, the gate driving signal (VG) is high.

According to an embodiment of the present disclosure, through the input buffer (135b), the short pulse generator (139), the SR latch (136b), and the inverter chain (137b), the scan signals (SCAN_1, SCAN_2) and the gate driving signal (VG) may be synchronized. Although FIG. 5B illustrates a state in which the scan signals (SCAN_1, SCAN_2) and the gate driving signal (VG) are completely synchronized, the present disclosure is not limited thereto, and the gate driving signal (VG) may be delayed relative to the scan signals (SCAN_1, SCAN_2).

According to the present disclosure, an operation of the sub scan driver (133b) of the scan driver IC (133) may be determined by the reset signal (RESET). For example, regardless of whether the main scan driver (130a) operates, the operation of the sub scan driver (133b) may be limited by maintaining the reset signal (RESET) at a high level.

As one example, according to an embodiment of the present disclosure, when the scan signals (SCAN_1, SCAN_2) are low, the gate driving signal (VG) is maintained low. Accordingly, when the main scan driver (130a) does not operate, the sub scan driver (133b) may also not operate. As a result, power consumption of the LED display driving device (50) may be reduced.

However, the present disclosure is not limited thereto, and even when the main scan driver (130a) operates, the sub scan driver (133b) may not operate by maintaining the reset signal (RESET) at a high level.

FIG. 6 is an operation timing diagram of the LED display driving device (50) according to an embodiment of the present disclosure.

In detail, FIG. 6 is a timing diagram illustrating a timing relationship between a vertical synchronization signal (V_{SYNC}) and a data signal (DATA).

Frame data may refer to each image constituting an image. One frame data may be composed of a plurality of segments.

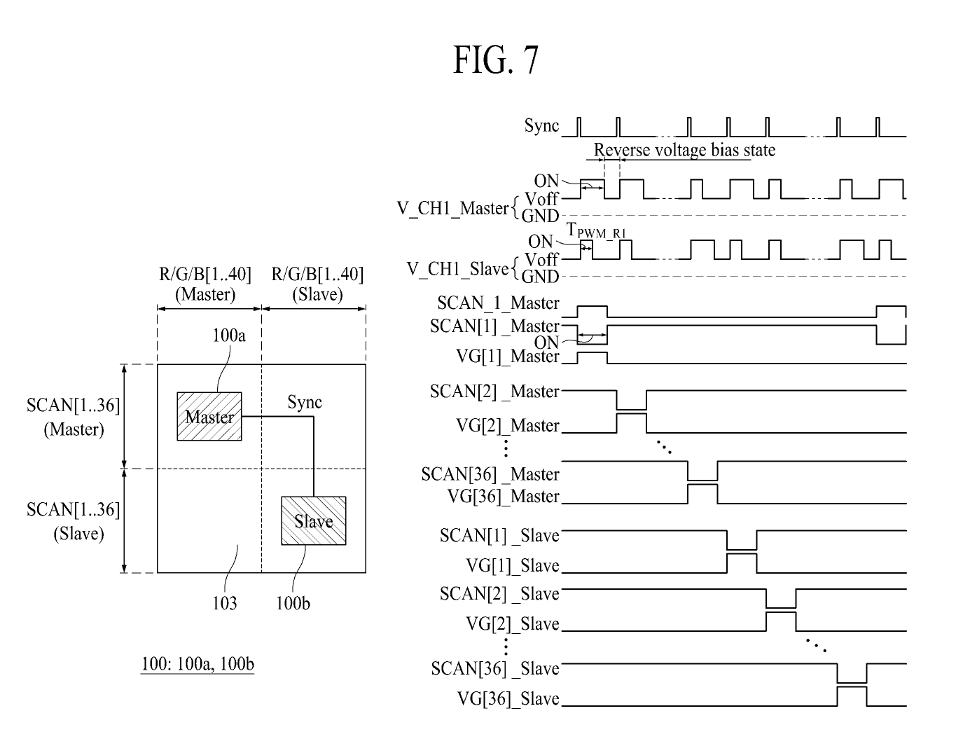

One segment may be a unit in which a scan operation of one cycle is performed. The scan operation may be an operation performed as the third switch (153) included in the scan driver (130) is turned on and then turned off. The scan operation of one cycle may mean that the scan operation is sequentially performed once from the first output stage (SCAN[1]) to the last output stage (SCAN[36]). Although FIG. 7 illustrates that the last output stage is the 36th output stage, the present disclosure is not limited thereto.

Referring to FIG. 6, after the vertical synchronization signal (V_{SYNC}) is activated, new frame data starts.

In detail, after transmission of N-th frame data (N Frame Data) is completed, the vertical synchronization signal (V_{SYNC}) for the N-th frame is activated. In addition, after the vertical synchronization signal (V_{SYNC}) for the N-th frame is activated, transmission of (N+1)-th frame data starts.

According to an embodiment of the present disclosure, after transmission of N-th frame data (N Frame Data) is completed and the vertical synchronization signal (V_{SYNC}) for the N-th frame is activated, the power reduction determination unit (111) may determine whether the master driver IC (100a) and the slave driver IC (100b) operate in a low power mode or a normal mode. In detail, the power reduction determination unit (111) of each of the master driver IC (100a) and the slave driver IC (100b) may determine whether the master driver IC (100a) and the slave driver IC (100b) operate in a low power mode or a normal mode.

FIG. 7 is an operation timing diagram of the LED display driving device (50) in a normal mode according to the present disclosure.

FIG. 7 schematically illustrates graphs of a channel voltage (V_CH1_Master) applied to a first red channel stage (R[1]_Master) corresponding to the master driver IC (100a) and a channel voltage (V_CH1_Slave) applied to a first red channel stage (R[1]_Slave) corresponding to the slave driver IC (100b).

In addition, FIG. 7 illustrates waveforms of a scan signal (T_{SCAN_ON1}) for controlling third switches (153) respectively connected to first to thirty-sixth output stages (SCAN[1]_Master to SCAN[36]_Master) corresponding to the master driver IC (100a) and first to thirty-sixth output stages (SCAN[1]_Slave to SCAN[36]_Slave) corresponding to the slave driver IC (100b).

According to an embodiment of the present disclosure, first red channel stages (R[1]_Master), first green channel stages (G[1]_Master), and first blue channel stages (B[1]_Master) to fortieth red channel stages (R[40]_Master), fortieth green channel stages (G[40]_Master), and fortieth blue channel stages (B[40]_Master), which correspond to the master driver IC (100a), correspond to the first channel line group (CL1), and the first output stages (SCAN[1]_Master) to the thirty-sixth output stages (SCAN[36]_Master) correspond to the first scan line group (SL1).

According to an embodiment of the present disclosure, first red channel stages (R[1]_Slave), first green channel stages (G[1]_Slave), and first blue channel stages (B[1]_Slave) to fortieth red channel stages (R[40]_Slave), fortieth green channel stages (G[40]_Slave), and fortieth blue channel stages (B[40]_Slave), which correspond to the slave driver IC (100b), correspond to the second channel line group (CL2), and the first output stages (SCAN[1]_Slave) to the thirty-sixth output stages (SCAN[36]_Slave) correspond to the second scan line group (SL2).

Referring to FIG. 7, the graphs of the channel voltages (V_CH1_Master, V_CH1_Slave) may include an ON period and an OFF period.

According to an embodiment of the present disclosure, the channel voltages (V_CH1_Master, V_CH1_Slave) may denote channel voltages applied to the corresponding channel lines (CL) when channel current is supplied to the channel lines (CL) corresponding to the first red channel stages (R[1]_Master, R[1]_Slave). In FIG. 7, channel voltages applied to channel lines corresponding to other channel stages are omitted.

According to an embodiment of the present disclosure, in the ON period, the first switch (151) is turned on, such that the channel current generated from the channel current source (123) may be supplied to the channel line (CL). In the OFF period, the first switch (151) is turned off, such that the channel current generated from the channel current source (123) may be blocked. The graphs of the channel voltages (V_CH1_Master, V_CH1_Slave) may include the ON period and the OFF period alternately arranged. Although the OFF period is not illustrated in the drawings, the OFF period may be a period excluding the period corresponding to the ON period.

For example, the ON period of the graphs of the channel voltages (V_CH1_Master, V_CH1_Slave) may mean a period in which the PWM signal (T_{PWM_R1}) is input, and the OFF period of the graphs of the channel voltages (V_CH1_Master, V_CH1_Slave) may mean a period in which the PWM signal (T_{PWM_R1}) is not input. In addition, in the ON period, when the PWM signal (T_{PWM_R1}) is turned on and channel current is thus supplied to the channel lines (CL) corresponding to the first red channel stages (R[1]_Master, R[1]_Slave), the channel voltages (V_CH1_Master, V_CH1_Slave) applied to the corresponding channel lines (CL) may increase from a reference voltage level (Voff) higher than a ground (GND) level, and when the PWM signal (T_{PWM_R1}) is turned off and supply of the channel current is suspended, the channel voltages (V_CH1_Master, V_CH1_Slave) may decrease again to the reference voltage level (Voff).

According to an embodiment of the present disclosure, the reason for maintaining the channel voltages (V_CH1_Master, V_CH1_Slave) at the reference voltage level (Voff) higher than the ground (GND) level in the OFF period is to reduce the time taken for the channel voltages (V_CH1_Master, V_CH1_Slave) to increase to a maximum value in accordance with supply of the channel current.

According to an embodiment of the present disclosure, the normal mode may include a display period and a non-display period. In this case, the display period may mean the ON period of the graphs of the channel voltages (V_CH1_Master, V_CH1_Slave), and the non-display period may mean the OFF period of the graphs of the channel voltages (V_CH1_Master, V_CH1_Slave).

According to an embodiment of the present disclosure, when the first switch (151) is turned off in the OFF period of the graphs of the channel voltages (V_CH1_Master, V_CH1_Slave), the second switch (152) may be turned on. In the OFF period, by turning off the first switch (151) and turning on the second switch (152), the channel-off voltage source (124) may generate the channel-off voltage (V_{OFF_R}).

In detail, in the normal mode, when the first switch (151) is turned off, the second switch (152) may be turned on, and when the first switch (151) is turned on, the second switch (152) may be turned off. According to the present disclosure, the data driver (120) being driven in the normal mode may mean that the data driver (120) is driven in a period other than a period in which the data driver (120) is driven in the low power mode.

Referring to FIG. 7, a control period of the scan signal (T_{SCAN_ON1}) may include an ON period and an OFF period. In the ON period, by turning off the third switch (153) and turning on the first scan transistor (154), the scan signal may be supplied to the scan line (SL). In the OFF period, by turning on the third switch (153) and turning off the first scan transistor (154), the scan offset voltage source (132) may supply the scan-off voltage (V_{OFF_SCAN}). Accordingly, the scan offset voltage source (132) may output a precharge current to the output stage (SCAN[1]) through the third switch (153). Although the OFF period is not illustrated in the drawings, the OFF period may be a period excluding the period corresponding to the ON period.

In detail, in the normal mode, when the third switch (153) is turned off, the first scan transistor (154) may be turned on, and when the third switch (153) is turned on, the first scan transistor (154) may be turned off. According to the present disclosure, the scan driver (130) being driven in the normal mode may mean that the scan driver (130) is driven in a period other than a period in which the scan driver (130) is driven in the low power mode.

According to an embodiment of the present disclosure, in the display period, the plurality of first switches (151) included in the master driver IC (100a) and the slave driver IC (100b) may be turned on, the plurality of second switches (152) may be turned off, the plurality of third switches (153) may be turned off, and the first scan transistor (154) may be turned on. Accordingly, the LEDs may be turned on.

In detail, in the display period, the plurality of channel current sources (123) corresponding to the first channel line group (CL1) and the second channel line group (CL2) may supply channel current to the corresponding channel lines (CL), and the plurality of first scan transistors (154) corresponding to the first scan line group (SL1) and the second scan line group (SL2) may be turned on.

According to an embodiment of the present disclosure, the synchronization signal (Sync) is activated prior to the ON period of the graphs of the channel voltages (V_CH1_Master, V_CH1_Slave). In detail, the PWM signal (T_{PWM_R1}) may be input after the synchronization signal (Sync) is activated.

According to an embodiment of the present disclosure, the scan-off voltage (V_{OFF_SCAN}) may be greater than the channel-off voltage (V_{OFF_R}).

According to an embodiment of the present disclosure, during the non-display period, when the first switch (151) is turned off and the first scan transistor (154) is turned off, a period during which the second switch (152) is turned on and the third switch (153) is turned on may be referred to as a reverse voltage bias interval.

In detail, during the non-display period, the plurality of channel-off voltage sources (124) corresponding to the first channel line group (CL1) and the second channel line group (CL2) may output the channel-off voltage (V_{OFF_R}) to the corresponding channel lines (CL), and the plurality of scan offset voltage sources (132) corresponding to the first scan line group (SL1) and the second scan line group (SL2) may output the scan-off voltage (V_{OFF_SCAN}) to the corresponding scan lines (SL).

The reverse voltage bias interval refers to a period in which an LED is maintained in a reverse voltage bias state due to a voltage difference between the channel-off voltage (V_{OFF_R}) and the scan-off voltage (V_{OFF_SCAN}). When the LED is maintained in the reverse voltage bias state, current may not flow through the LED. The LED display driving device (50) according to the present disclosure may improve leakage current by maintaining the LED in the reverse voltage bias state in each non-display period in the normal mode.

Referring to FIGS. 7, 8, and 9, a description of the scan signal (SCAN_1_Master) is omitted because the same is redundant with the description of the scan signals (SCAN_1, SCAN_2) shown in FIGS. 4B and 5B. The scan signal (SCAN_1_Master) may correspond to the scan signal (T_{SCAN_ON1}) for turning on the first scan transistor (154) corresponding to the first output stage (SCAN[1]_Master).

Referring to FIG. 7, voltages at the first output stage (SCAN[1]_Master) to the thirty-sixth output stage (SCAN[36]_Master) may correspond to the scan input signals (SCAN[1], SCAN[2]) shown in FIGS. 4B and 5B.

Referring to FIGS. 7, 8, and 9, the gate driving signals (VG[1]~[36]_Master) correspond to gate driving signals (VG) for driving the second scan transistors (138a, 138b) sharing scan lines (SL) with the first scan transistors (154) corresponding to the first output stage (SCAN[1]_Master) to the thirty-sixth output stage (SCAN[36]_Master). The gate driving signals (VG[1]~[36]_Slave) correspond to gate driving signals (VG) for driving the second scan transistors (138a, 138b) sharing scan lines (SL) with the first scan transistors (154) corresponding to the first output stage (SCAN[1]_Slave) to the thirty-sixth output stage (SCAN[36]_Slave).

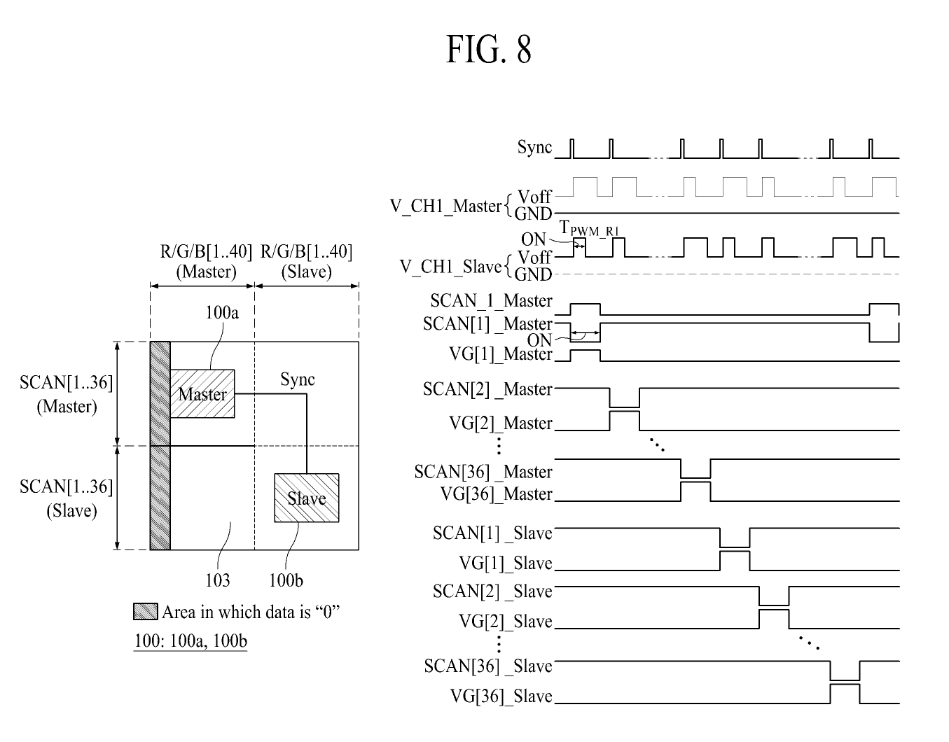

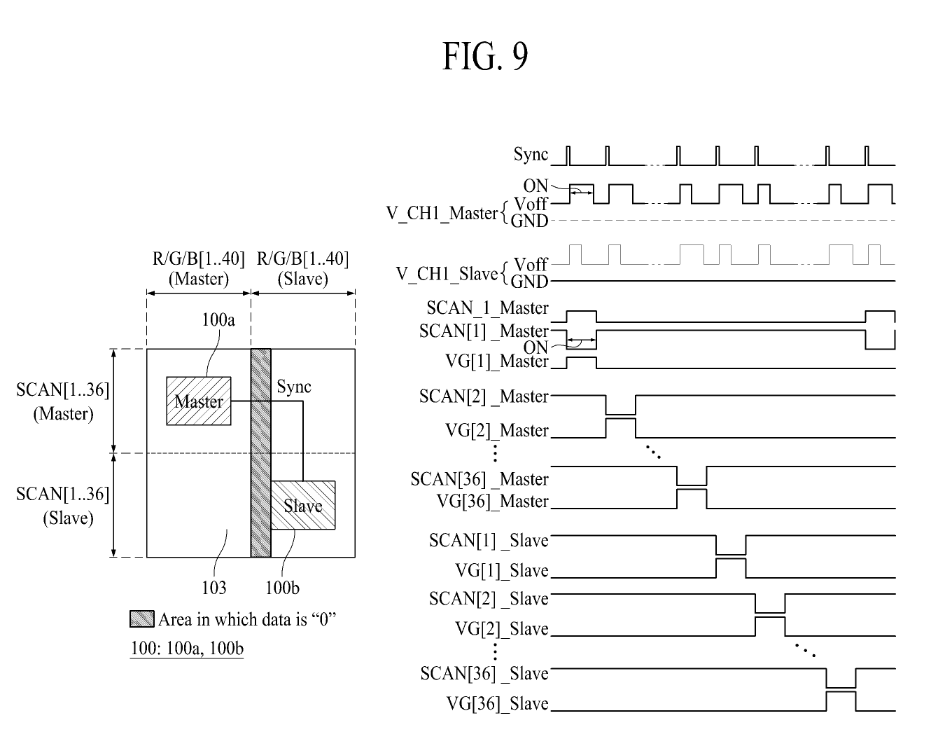

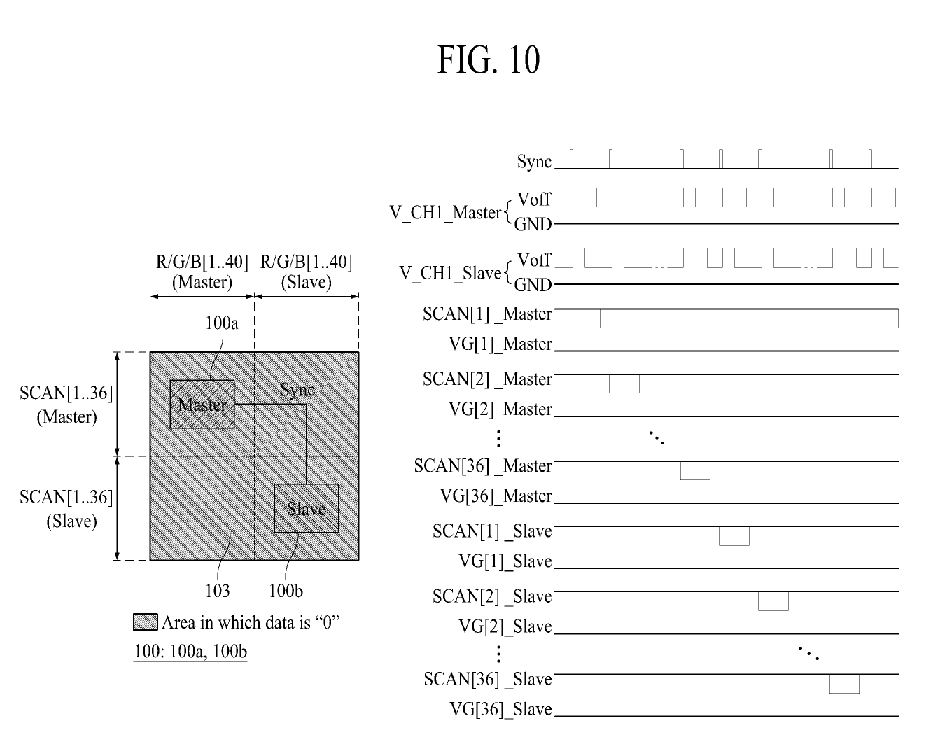

FIG. 8 is an operation timing diagram of the LED display driving device (50) in a low power mode according to the present disclosure. FIG. 9 is an operation timing diagram of the LED display driving device (50) in another low power mode according to the present disclosure. FIG. 10 is an operation timing diagram of the LED display driving device (50) in still another low power mode according to the present disclosure.

In detail, the left drawings of FIGS. 8 - 10 illustrate partial areas of the display panel (101) according to an embodiment of the present disclosure. The left drawings of FIGS. 8 - 10 illustrate areas in which data is “0” in part of the display panel (101). In detail, the left drawings illustrate that areas in which data is “0” exist in the plurality of display units (103). The fact that data is “0” may mean that the first switches (151) and the second switches (152) of the channel stages (121) corresponding to the relevant areas are turned off. In detail, the plurality of channel current sources (123) and the plurality of AMPs (122), which correspond to the areas in which data is “0,” are disconnected from the corresponding channel lines (CL).

According to an embodiment of the present disclosure, the data driver (120) and the scan driver (130) of each of the master driver IC (100a) and the slave driver IC (100b) may be driven in a low power mode or a normal mode.

For example, the data driver (120) being driven in the low power mode means that all switches corresponding to some or all of the plurality of channel stages (121) in the data driver (120) are turned off. In addition, the scan driver (130) being driven in the low power mode means that the third switches (153) corresponding to some or all of the plurality of output stages (131) in the scan driver (130) are maintained in a turn-on state, and the first scan transistors (154) are maintained in a turn-off state.

According to an embodiment of the present disclosure, the data driver (120) being in the normal mode means that the data driver (120) does not include any channel stage (121) in which all switches corresponding to any one channel stage (121) are turned off. In detail, the data driver (120) being in the normal mode may mean that no area in which data is 0 exists in the display units (103) based on the second direction (Y). In addition, the scan driver (130) being in the normal mode means that the scan driver (130) does not include any output stage (131) in which the third switch (153) corresponding to any one output stage (131) is maintained in a turn-on state and the first scan transistor (154) is maintained in a turn-off state. In detail, the scan driver (130) being in the normal mode may mean that no area in which data is 0 exists in the display units (103) based on the first direction (X).

Referring to FIG. 8, when the first switches (151) and the second switches (152) corresponding to some of the plurality of channel stages (121) of the master driver IC (100a) are turned off, the data driver (120) of the master driver IC (100a) may be driven in the low power mode, the scan driver (130) of the master driver IC (100a) may be driven in the normal mode, the data driver (120) of the slave driver IC (100b) may be driven in the normal mode, and the scan driver (130) of the slave driver IC (100b) may be driven in the normal mode.

For example, among the data driver (120) of the master driver IC (100a), the first switches (151) and the second switches (152) of the channel stages (121) corresponding to the areas in which data is “0” are turned off. In this case, the channel voltage (V_CH1_Master) applied to the channel lines (CL) corresponding to the areas in which data is “0” may be at a ground (GND) level.

For example, when areas in which data is “0” exist in the first display unit (103a) and the third display unit (103c) based on the second direction (Y), the plurality of channel current sources (123) and the plurality of AMPs (122), which correspond to the areas in which data is “0” in the first channel line group (CL1), are disconnected from the corresponding channel lines (CL), the plurality of channel current sources (123) corresponding to the second channel line group (CL2) supply channel current to the corresponding channel lines (CL), and the plurality of first scan transistors (154) corresponding to the first scan line group (SL1) and the second scan line group (SL2) may be turned on.

A description of the synchronization signal (Sync) shown in FIG. 8 is the same as the description of the synchronization signal (Sync) shown in FIG. 7.

FIG. 8 illustrates, as one example, that the first red channel stage (R[1]_Master) is the channel stage (121) corresponding to an area in which data is “0.”

Referring to FIG. 9, when the first switches (151) and the second switches (152) corresponding to some of the plurality of channel stages (121) of the slave driver IC (100b) are turned off, the data driver (120) of the slave driver IC (100b) may be driven in the low power mode, the scan driver (130) of the slave driver IC (100b) may be driven in the normal mode, the data driver (120) of the master driver IC (100a) may be driven in the normal mode, and the scan driver (130) of the master driver IC (100a) may be driven in the normal mode.

For example, among the data driver (120) of the slave driver IC (100b), the first switches (151) and the second switches (152) of the channel stages (121) corresponding to the areas in which data is “0” are turned off. In this case, the channel voltage (V_CH1_Slave) applied to the channel lines (CL) corresponding to the areas in which data is “0” may be at a ground (GND) level.

For example, when areas in which data is “0” exist in the second display unit (103b) and the fourth display unit (103d) based on the second direction (Y), the plurality of channel current sources (123) and the plurality of AMPs (122), which correspond to the areas in which data is “0” in the second channel line group (CL2), are disconnected from the corresponding channel lines (CL), the plurality of channel current sources (123) corresponding to the first channel line group (CL1) supply channel current to the corresponding channel lines (CL), and the plurality of first scan transistors (154) corresponding to the first scan line group (SL1) and the second scan line group (SL2) may be turned on.

A description of the synchronization signal (Sync) shown in FIG. 9 is the same as the description of the synchronization signal (Sync) shown in FIGS. 7 and 8.

FIG. 9 illustrates, as one example, that the first red channel stage (R[1]_Slave) is the channel stage (121) corresponding to an area in which data is “0.”

Referring to FIG. 10, when all first switches (151) and second switches (152) of the plurality of channel stages (121) of the master driver IC (100a) and the plurality of channel stages (121) of the slave driver IC (100b) are turned off, the data driver (120) of the master driver IC (100a) may be driven in the low power mode, the scan driver (130) of the master driver IC (100a) may be driven in the low power mode, the data driver (120) of the slave driver IC (100b) may be driven in the low power mode, and the scan driver (130) of the slave driver IC (100b) may be driven in the low power mode.

For example, all switches in the data drivers (120) of the master driver IC (100a) and the slave driver IC (100b) are turned off, the third switches (153) in the scan drivers (130) are maintained in a turn-on state, and the first scan transistors (154) are maintained in a turn-off state.

For example, when the entirety of the first display unit (103a), the second display unit (103b), the third display unit (103c), and the fourth display unit (103d) are areas in which data is “0,” the plurality of channel current sources (123) and the plurality of AMPs (122) of the first channel line group (CL1) and the second channel line group (CL2) are disconnected from the corresponding channel lines (CL), and the plurality of scan offset voltage sources (132) corresponding to the first scan line group (SL1) and the second scan line group (SL2) may be connected to the corresponding plurality of LEDs.

In this case, the channel voltages (V_CH1_Master, V_CH1_Slave) applied to the channel lines (CL) corresponding to the areas in which data is “0” may be at a ground (GND) level.

Referring to FIG. 10, the gate driving signal (VG) may be maintained at a low level.

Referring to FIG. 10, the synchronization signal (Sync) may be deactivated.

According to the present disclosure, the following advantageous effects may be obtained.

The LED display driving device according to an embodiment of the present disclosure may reduce a turn-on resistance (Ron) applied to a scan line during scan driving by further including a scan driver IC.

The LED display driving device according to an embodiment of the present disclosure may reduce power consumption by including a smaller number of driver ICs compared to the number of display units.

The LED display driving device according to another embodiment of the present disclosure may reduce power consumption by operating each of the master driver IC and the slave driver IC in a low power mode.

The LED display driving device according to still another embodiment of the present disclosure may improve leakage current by maintaining an LED in a reverse bias state in a normal mode.

It will be apparent to those skilled in the art that the present disclosure described above is not limited by the above-described embodiments and the accompanying drawings and that various substitutions, modifications and variations may be made in the present disclosure without departing from the spirit or scope of the disclosures. Consequently, the scope of the present disclosure is defined by the accompanying claims and it is intended that all variations or modifications derived from the meaning, scope and equivalent concept of the claims fall within the scope of the present disclosure.

What is claimed is:

1. An LED display driving device comprising:
an LED driver IC configured to drive a plurality of LEDs arranged for each of a plurality of display areas included in a display panel,
wherein the LED driver IC includes a master driver IC and a slave driver IC configured to receive data and a clock from the master driver IC,
wherein each of the master driver IC and the slave driver IC includes a scan driver having a plurality of main scan drivers configured to respectively drive a plurality of scan lines, and
wherein the LED display driving device further includes a scan driver IC having a plurality of sub scan drivers configured to respectively share corresponding scan lines with the plurality of main scan drivers.

2. The LED display driving device of claim 1,
wherein the scan driver includes a plurality of first scan transistors respectively connected to the plurality of scan lines and selectively turned on or off according to a scan signal to select scan lines connected to LEDs to emit light,
wherein each of the plurality of first scan transistors is provided in a corresponding one of the plurality of main scan drivers, and
wherein the scan driver IC includes a plurality of second scan transistors turned on or off by a gate driving signal synchronized with the scan signal for turning on or off the plurality of first scan transistors.

3. The LED display driving device of claim 1,
wherein each of the plurality of sub scan drivers includes:
an input buffer configured to receive a voltage applied to a corresponding scan line among the plurality of scan lines and to output a first control signal;
a NOR gate configured to receive the first control signal and a reset signal supplied from the LED driver IC and to output a first signal; and
an inverter chain configured to receive the first signal and to output a gate driving signal,
wherein each of the plurality of second scan transistors is provided in a corresponding one of the plurality of sub scan drivers, and
wherein an operation of the plurality of sub scan drivers is determined by the reset signal supplied from the LED driver IC.

4. The LED display driving device of claim 3,
wherein each of the master driver IC and the slave driver IC includes a display controller configured to control the scan driver, and
wherein the reset signal is output from the display controller.

5. The LED display driving device of claim 1,
wherein each of the plurality of sub scan drivers includes:
an input buffer configured to receive a voltage applied to a corresponding scan line among the plurality of scan lines and to output a second signal;
a short pulse generator configured to output the second signal as a second control signal of a short pulse;
an SR latch configured to receive the second control signal and a reset signal supplied from the LED driver IC at a set terminal and a reset terminal, respectively, latch the same, and output a third signal; and
an inverter chain configured to receive the third signal and output a gate driving signal,
wherein each of the plurality of second scan transistors is provided in a corresponding one of the plurality of sub scan drivers, and
wherein an operation of the plurality of sub scan drivers is determined by the reset signal supplied from the LED driver IC.

6. The LED display driving device of claim 5,
wherein each of the master driver IC and the slave driver IC includes a display controller configured to control the scan driver, and
wherein the reset signal is output from the display controller.

7. The LED display driving device of claim 1,
wherein the display area includes a plurality of display units,
wherein the master driver IC drives a first scan line group corresponding to first and second display units adjacent to each other in a first direction among the plurality of display units and a first channel line group corresponding to first and third display units adjacent to each other in a second direction perpendicular to the first direction, and
wherein the slave driver IC drives a second scan line group corresponding to third and fourth display units adjacent to each other in the first direction among the plurality of display units and a second channel line group corresponding to second and fourth display units adjacent to each other in the second direction.

8. The LED display driving device of claim 7,
wherein the master driver IC is disposed in an area corresponding to the first display unit, and
wherein the slave driver IC is disposed in an area corresponding to the fourth display unit.

9. The LED display driving device of claim 8,
wherein the scan driver IC includes:
a first scan driving group disposed in a display unit corresponding to the master driver IC; and
a second scan driving group disposed in a display unit corresponding to the slave driver IC.

10. The LED display driving device of claim 7,
wherein each of the master driver IC and the slave driver IC includes:
a data driver configured to output a data signal corresponding to image data to a plurality of LEDs connected to respective channel lines through a plurality of channel lines extending in the second direction; and
a display controller configured to control the data driver and the scan driver.

11. The LED display driving device of claim 10,
wherein each of the master driver IC and the slave driver IC further includes a synchronization unit configured to output a synchronization signal in response to a synchronization control signal output from the display controller, and
wherein, based on the synchronization signal output from the master driver IC, a scan signal of the master driver IC is synchronized with a scan signal of the slave driver IC.

12. The LED display driving device of claim 10,
wherein each of the master driver IC and the slave driver IC further includes an interface and a power reduction determination unit configured to receive data from the respective interface,
wherein data input from the outside is transferred to the interface of the slave driver IC through the interface of the master driver IC, and
wherein the power reduction determination unit of each of the master driver IC and the slave driver IC determines whether to operate in a low power mode or a normal mode based on the data received from the respective interface.

13. The LED display driving device of claim 10,
wherein the data driver includes:
a plurality of channel stages configured to supply LED power to the plurality of channel lines based on a data signal;
a plurality of channel current sources configured to supply channel current to corresponding channel lines among the plurality of channel lines;
a plurality of first switches configured to connect the plurality of channel stages and the plurality of channel current sources;
a plurality of channel-off voltage sources configured to output a channel-off voltage to corresponding channel lines among the plurality of channel lines; and
a plurality of AMPs configured to amplify a difference between the channel-off voltage output from the channel-off voltage source and a voltage fed back from an output stage and output the amplified difference to the output stage, and
wherein the scan driver includes:
a plurality of scan offset voltage sources configured to output a scan-off voltage to corresponding scan lines among the plurality of scan lines; and
a plurality of first scan transistors respectively connected to the plurality of scan lines and configured to be selectively turned on or off according to a scan signal to select scan lines connected to LEDs to be turned on.

14. The LED display driving device of claim 13,
wherein each of the master driver IC and the slave driver IC is driven in a normal mode or a low power mode,
wherein the normal mode includes a display period and a non-display period, and
wherein, when each of the master driver IC and the slave driver IC is driven in the normal mode, during the display period, the plurality of channel current sources corresponding to the first and second channel line groups supply channel current to corresponding channel lines, and the plurality of first scan transistors corresponding to the first and second scan line groups are turned on.

15. The LED display driving device of claim 13,
wherein the scan-off voltage is greater than the channel-off voltage.

16. An LED display device comprising:
a display panel including a plurality of LEDs disposed in a plurality of subpixels in which a plurality of channel lines and a plurality of scan lines cross each other; and
an LED display driving device configured to supply channel current to the plurality of LEDs to cause the plurality of LEDs to emit light,
wherein the LED display driving device includes an LED driver IC configured to drive the plurality of LEDs,
wherein the LED driver IC includes a master driver IC and a slave driver IC configured to receive data and a clock from the master driver IC,
wherein each of the master driver IC and the slave driver IC includes a scan driver having a plurality of main scan drivers configured to respectively drive the plurality of scan lines, and
wherein the LED display driving device further includes a scan driver IC having a plurality of sub scan drivers configured to respectively share the plurality of scan lines with the plurality of main scan drivers.

17. The LED display device of claim 16,
wherein the scan driver includes a plurality of first scan transistors respectively connected to the plurality of scan lines and selectively turned on or off according to a scan signal to select scan lines connected to LEDs to emit light,
wherein each of the plurality of first scan transistors is provided in a corresponding one of the plurality of main scan drivers, and
wherein the scan driver IC includes a plurality of second scan transistors turned on or off by a gate driving signal synchronized with the scan signal for turning on or off the plurality of first scan transistors.

18. The LED display device of claim 16,
wherein each of the plurality of sub scan drivers includes:
an input buffer configured to receive a voltage applied to a corresponding scan line among the plurality of scan lines and to output a first control signal;
a NOR gate configured to receive the first control signal and a reset signal supplied from the LED driver IC and to output a first signal; and
an inverter chain configured to receive the first signal and to output a gate driving signal,
wherein each of the plurality of second scan transistors is provided in a corresponding one of the plurality of sub scan drivers, and
wherein an operation of the plurality of sub scan drivers is determined by the reset signal supplied from the LED driver IC.

19. The LED display device of claim 18,
wherein each of the master driver IC and the slave driver IC includes a display controller configured to control the scan driver, and
wherein the reset signal is output from the display controller.

20. The LED display device of claim 16,
wherein each of the plurality of sub scan drivers includes:
an input buffer configured to receive a voltage applied to a corresponding scan line among the plurality of scan lines and to output a second signal;
a short pulse generator configured to output the second signal as a second control signal of a short pulse;
an SR latch configured to receive the second control signal and a reset signal supplied from the LED driver IC at a set terminal and a reset terminal, respectively, latch the same, and output a third signal; and
an inverter chain configured to receive the third signal and to output a gate driving signal,
wherein each of the plurality of second scan transistors is provided in a corresponding one of the plurality of sub scan drivers, and
wherein an operation of the plurality of sub scan drivers is determined by the reset signal supplied from the LED driver IC.
